(19) United States
(12) Patent Application Publication
(10) Pub. No.: US 2010/0310435 A1
(43) Pub. Date: Dec. 9, 2010

(54) OZONE GENERATOR

(75) Inventors: Richard Little, Southampton (GB); David Briggs, Silchester (GB)

Correspondence Address: BUCHALTER NEMER, 18400 VON KARMAN AVE., SUITE 800, IRVINE, CA, 92612, US

(73) Assignee: Jenact Limited, Whitchurch (GB)

(21) Appl. No.: 12/796,366

(22) Filed: Jun. 8, 2010

(30) Foreign Application Priority Data
Jun. 9, 2009 (GB) 0909889.8

(51) Int. Cl. B01J 19/12; C01B 13/10

(52) U.S. Cl. 422/186.18; 422/186.3

(57) ABSTRACT

This invention relates to apparatus for maximising ozone generation from a UV bulb. The apparatus includes a UV bulb which emits UV light below 200 nm, peaking at 185 nm. Bulbs emitting UV light at 185 nm are well known to generate ozone but generally also emit UV light at 254 nm which is well known to deplete ozone. The concept of the present invention is to create an environment where air or oxygen carrying gas can be exposed to the 185 nm and 254 nm UV light outputs from a bulb in such a way that the 185 nm ozone generating effect is enhanced and 254 nm ozone depleting effect is reduced. The apparatus also includes a member which may either be transmissive to or non-transmissive to UV light at 254 nm and the environment in which the effect of the UV light at 185 nm is enhanced exists between the UV lamp and the member.

This application is a United States Utility application that claims priority to co-pending United Kingdom Application No. 0909889.8 filed on Jun. 9, 2009, which is incorporated herein in its entirety by reference.

The invention relates to an ozone generator. In particular it relates to an ozone generator including a UV energy source.

Ozone is commonly used to enhance oxidation, reduce odours and due to its germicidal properties to disinfect and sanitise objects, gases, liquids and areas. Because ozone can be generated from oxygen present in the air and because it later will naturally break down into oxygen, it has advantages in respect of logistics and in chemical safety in relation to many other gases with disinfectant properties.

UV based ozone generators are used to convert oxygen to ozone, by exposing the oxygen in an oxygen-containing gas, to UV light at wavelengths between 170 and 200 nm, peaking at 185 nm. The UV light causes the oxygen molecule (O₂) to dissociate into individual oxygen atoms, which then react with an oxygen molecule to form an ozone molecule (O₃). Thus, by exposing an oxygen-containing gas to UV light, the concentration of ozone is increased. An example of such a device is illustrated in U.S. Pat. No. 4,857,277.

There are problems associated with this device. UV light at 185 nm is well known to generate ozone and UV light at 254 nm is well known to degenerate ozone. A Mercury based UV lamp, operating in the low pressure phase, typically will produce more UV intensity at 254 nm then at 185 nm although the conversion rate at 185 nm is greater than the destruction rate at 254 nm and so there is a residual surplus of ozone. Therefore, as the device described in U.S. Pat. No. 4,857,277 does not differentiate between the wavelengths emitted by the UV bulb, and the gases reacting with the UV light at 185 nm are allowed to mix with the gases reacting with the UV light at 254 nm, the device limits the rate at which it can produce ozone. Furthermore, UV bulbs generally produce far more UV light at 254 nm than UV light at 185 nm.

In air, the absorbance of UV light at 185 nm is very high due to the reaction between the photon and the oxygen or water molecules, abundant in air. Therefore, the average transmission distance of UV light at 185 nm is very short.

At wavelengths above 200 nm, the absorbance of light is a lot less as the light does not react with the oxygen or water molecules in the air. However, UV light at 254 nm reacts with the ozone molecules in the air, causing them to degenerate into an oxygen molecule and oxygen atom.

As the concentration of ozone in air is far less than the concentration of oxygen in air, the absorbance of UV light at 254 nm is very low.

Therefore, the average transmission distance of UV light at 254 nm, in air, is a lot greater than the average transmission distance of UV light at 185 nm.

In accordance with a first aspect of the present invention there is provided an ozone generator comprising a non UV reflective tubular member arranged to receive a flow of oxygen or oxygen-carrying gas, a cylindrical UV light source coaxial to, being of a smaller diameter than and located within the tubular member and arranged to produce UV light, including UV light generally between 170 and 200 nm, peaking at 185 nm, and UV light generally between 240 and 270 nm, peaking at 254 nm, and an internal surface of the tubular member being located a predetermined distance from a surface of the UV light source such that absorption of 185 nm UV light by the oxygen or oxygen-carrying gas is greater as a ratio to the absorption of 254 nm UV light by the same gas in the same distance.

In the present invention, an annular space in the tubular member around the UV bulb is typically dimensioned, such that the oxygen or oxygen-carrying gas with maximum absorption of the UV light generally between 185 nm is isolated within the tubular member and separated from any oxygen or oxygen-carrying gas that is too far away from the UV bulb for the 185 nm UV light to have any appreciable net ozone generating effect and where the 254 nm UV light may have an ozone reduction effect.

Advantageously, therefore, the oxygen or oxygen-carrying gas inside the tubular member does not mix with the oxygen or oxygen-carrying gas that is too far away from the UV bulb for the 185 nm UV light to have any appreciable net ozone generating effect and where 254 nm UV light would have an ozone reducing effect. Therefore, the concentration of ozone in the annular space within the tubular member is greater than it would be without the tubular member.

The purpose of the invention is to create a contained space where the effect of the 185 nm UV light acting on the oxygen or oxygen carrying gas as a ratio to the effect of the 254 nm UV light breaking down is greatly enhanced.

The member may be a sleeve in which the UV bulb is situated.

Preferably, the tubular member is arranged to absorb or be substantially transparent to UV germicidal light generally centred around 254 nm,

An oxygen-containing gas flows between the bulb and member. The apparatus may further include an outlet or outlets which allows the gas to exit.

Preferably the UV bulb is manufactured from synthetic quartz which has minimal losses to transmission of short wave UVC at 185 nm.

Preferably the member is either constructed from material transparent to UV germicidal light generally centred around 254 nm such as quartz, or from material that either absorbs UV germicidal light generally centred around 254 nm UV light or is coated on the inside with such material.

Advantageously, the distance between the bulb and the tubular member is eight to twelve millimetres.

A specific embodiment of the present invention will now be described, by way of example, with reference to the following drawings in which:

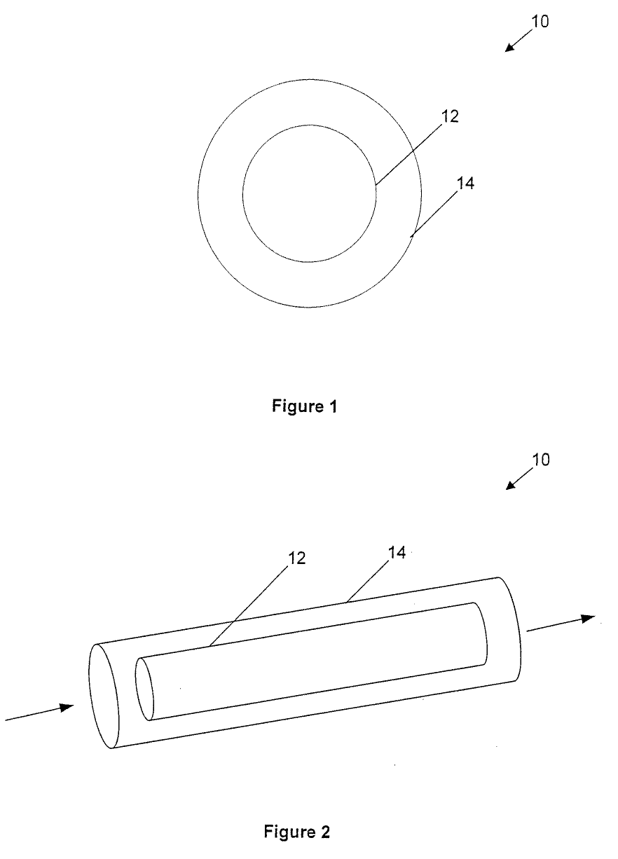

FIG. 1 is a cross section through an apparatus of the invention;

FIG. 2 is a perspective view of an apparatus of the invention;

The apparatus 10 is provided with a UV source 12 to produce UV light. The UV source 12 is arranged to emit UVC light including, at least light at wavelengths of 185 nm. A member 14, which may take the form of an outer conductor of a co-axial structure, is situated between 8 and 12 mm from the outer surface of the UV source 12. The skilled person will understand, however, that the distance between the member 14 and the UV source 12 may be varied to produce the desired effect, with greater distances between the member 14 and UV source 12 tending to increase the volumetric proportion reacting with the 254 nm light relative to 185 nm light.

In FIGS. 1 and 2, the apparatus 10 includes a member 14 that is transmissive to

UV light having a wavelength of 254 nm and is positioned approximately 1 cm from the UV light source 12. This means that, as light at 185 nm only penetrates between approximately 8 and 12 mm in air, light at 185 nm will be almost fully attenuated in the region between the UV source 12 and the member 14.

Light at 254 nm can penetrate greater distances in air than 185 nm, so it passes through (or is absorbed by) the member 14 with minimal absorption by any gas, such as an oxygen-containing gas, present between the UV source 12 and the member 14, and passes out of the apparatus 10. This means that the 254 nm light will interact with only a small number of ozone molecules between the UV source 12 and the member 14, thus only a small amount of ozone will be degraded by the 254 nm light in the region between the UV source 12 and member 14.

Since light at 185 nm catalyses the generation of ozone, the structure of the apparatus 10 means that the ozone generated by the 185 nm light's interaction with the oxygen-containing gas is not degenerated by 254 nm light, which degrades ozone, as 254 nm light passes out of the region. Additionally, as movement of the ozone is restricted by the presence of the member 14, ozone diffusion through the member is prevented.

Gases can be passed between the UV source 12 and the member 14, allowing the gas to be irradiated by UV light. Alternatively, gases with increased ozone levels may be extracted from the region and used to sterilise objects outside the region.

The member 14 may be made from quartz or any other material which allows UV light at 254 nm to pass through. Alternatively, it may be made from a material which absorbs and does not reflect light at 254 nm.

The UV source 12 may be any bulb arranged to transmit light at wavelengths between 170 and 200 nm, peaking at 185 nm, and may include electrodes or be electrodeless. Additionally, it is preferable that the bulb is manufactured from synthetic quartz to minimise 185 nm light attenuation by the bulb.

1. An ozone generator comprising
a) a non UV reflective tubular member arranged to receive a flow of oxygen or oxygen-carrying gas;
b) a generally cylindrical UV light source coaxial to, being of a smaller diameter than and located within the tubular member and arranged to produce UV light, including UV light generally between 170 and 200 nm, peaking at 185 nm, and UV light generally between 240 and 270 nm, peaking at 254 nm; and
c) an internal surface of the tubular member being located a predetermined distance from a surface of the UV light source such that absorption of 185 nm UV light by the oxygen or oxygen-carrying gas is greater as a ratio to the absorption of 254 nm UV light by the same gas in the same distance.

2. An ozone generator as claimed in claim 1, wherein the tubular member is impermeable to ozone.

3. An ozone generator as claimed in claim 1, wherein the tubular member is arranged to absorb or be substantially transparent to UV light at the 254 nm wavelength.

4. An ozone generator as claimed in claim 1, wherein the predetermined distance between the UV light source and the tubular member is between an average transmission distance of 185 nm light in the oxygen or the oxygen-carrying gas and an average transmission distance of 254 nm light in the oxygen or the oxygen-carrying gas.

5. An ozone generator as claimed in claim 1, wherein the predetermined distance from the internal surface of the UV light source to the tubular member is such that absorption of 185 nm UV light by the oxygen or oxygen carrying gas is maximised as a ratio to the absorption of 254 nm UV light by the same gas in the same distance.

6. An ozone generator as claimed in claim 1, wherein the predetermined distance between the UV light source and the tubular member is between 8 to 12 mm.

7. An ozone generator as claimed in claim 1 further including an outlet for removing gas from the area between the bulb and the tubular member.

8. An ozone generator as claimed in claim 1 wherein the UV light source is manufactured from synthetic quartz.

9. An ozone generator as claimed in claim 1 wherein the UV light source is an electrodeless UV bulb, and forms a coaxial transmission line with the tubular member.

10. An ozone generator as claimed in claim 1, wherein the UV light source includes an electrode.
